(19) United States
(12) Patent Application Publication
(10) Pub. No.: US 2026/0132074 A1
(43) Pub. Date: May 14, 2026

(54) GREENHOUSE GLAZING

(71) Applicant: AGC GLASS EUROPE, Louvain-la-Neuve (BE)

(72) Inventors: Seyedmohammad SHAYESTEHAMINZADEH, Gosselies (BE); Julien JEANFILS, Gosselies (BE); Fabrice DUFOUR, Gosselies (BE); Bruno CHAUSTEUR, Gosselies (BE)

(73) Assignee: AGC GLASS EUROPE, Louvain-la-Neuve (BE)

(21) Appl. No.: 19/118,239

(22) PCT Filed: Oct. 3, 2023
(86) PCT No.: PCT/EP2023/077352

§ 371 Date: Apr. 3, 2025

(30) Foreign Application Priority Data
Oct. 6, 2022 (EP) 22200100.0

(51) Int. Cl. A01G 9/14; C03C 15/00; C03C 17/23; C03C 17/36; C03C 27/10

(52) U.S. Cl. CPC C03C 15/00; A01G 9/1469; C03C 17/23; C03C 17/3626; C03C 17/3644; C03C 17/366; C03C 17/3681; C03C 27/10; A01G 2009/1484; C03C 2217/425; C03C 2217/478; C03C 2217/732

(57) ABSTRACT

A glazing for greenhouses designed to fit cold climate. The glazing is a vacuum isolating glazing unit with two glass substrates and each glass substrate has at least one main surface with a specific roughness and an antireflective layer. The VIG for greenhouses has a high PAR transmittance, a good hortiscatter and a good thermal insulation.

### TECHNICAL FIELD

The present invention relates to vacuum insulating glazing (VIG) unit for greenhouses. The vacuum insulating glazing of the invention comprises at least one textured glass substrate which may advantageously be coated with an antireflective layer. The vacuum insulating glazing of the invention has a low U value, together with a sufficient PAR light transmission. More particularly, the glazing of the invention is characterized through a low U value which is not dependant of the glazing inclination.

### BACKGROUND ART

For an optimal plant growth in a greenhouse, some requirements need to be fulfilled. Namely the plants must receive enough light which is well distributed all over the greenhouse volume, along with a specific homogeneous temperature range, as well as enough carbon dioxide and humidity. More particularly, the PAR light, corresponding to a wavelength between 400 and 700 nm is the light responsible for crop growth and specific attention has to be taken into account to keep the amount of this part of light distributed inside the greenhouse as big and as homogeneous as possible.

In cold climate, the inside temperature of the greenhouse may decrease dramatically because of thermal energy losses through the glass due to poor thermal insulation i.e. high emissivity of normal soda lime glass. To maintain production, heating is requested to avoid all problems associated with the temperature decrease as the insufficient heat for plant growth, but also water condensation on structural surface and on the plant leaves.

To avoid heat loss, the immediate answer is insulation. Since a greenhouse is mainly a glass construction, a good chance to decrease the heat loss is to decrease the thermal transmittance thanks to double glazing structure and/or solar control coatings. Some old patents like GB2022671A, GB2094383B or DE2532633B1 have already proposed a greenhouse including double glazing. Nevertheless very few users have chosen such kind of structure. There are some reasons for the poor success of double glazed greenhouses. First such construction are very expensive but above all, a major issue of double glazing unit is that light reflection increases and light transmission drastically decreases. A lower light transmission results in a lower yield of plants crops. As a consequence, usage of a double glazing might be advantageous in cases where heating the greenhouse is an obligation. This allow to decrease the heating costs despite the double glazing will induce some big loss in light transmittance and more particularly in PAR light transmittance, and then also, results in a major yield loss.

A second problem of double glazing unit including two glasses separated by a space containing a gas atmosphere, is that due to convection, heat exchange between inside and outside is dependant of the inclination of the double glazing unit. This means that the U value is dependant of the glazing inclination. For example, starting from a normal U value (for a vertical glazing, like the wall of the greenhouse) of about 1.1, this increases to 1.7 when the vacuum glazing unit is positioned at 22° (related to the ground, as the roof of the greenhouse). Another problem of double glazing unit is the poor durability of the sealing. With time and exposure to climatic rigors, defects in the sealing may be responsible for water entrance inside the space between the two glasses and compromise the insulation properties of double glazing.

The current environmental problem makes people in all sectors consider the question of carbon dioxide release. A bad thermal insulation for a greenhouse will result in an higher heating need and as a final consequence a higher carbon dioxide release in the atmosphere. This is why greenhouse thermal insulation is becoming an important issue to solve. The inventors have found that the problems described above may be solved by using a vacuum insulating glazing which incorporates particular glass substrates. The present invention is thus proposing a solution to use vacuum insulating glazing for greenhouse allowing a better thermal insulation, independent from the position and inclination of the glazing and keeping a sufficient PAR light transmission. Another advantage can be found in the use of a glass frit as sealing of the VIG to avoid long term degradation due to climatic harshness.

### Object of the Invention

The objective of the invention is to design a vacuum insulating glazing (VIG) unit suitable for the construction of a greenhouse fitted for cold climate. The vacuum insulating glazing of the invention for the greenhouse must have good insulation characteristics combined with a good PAR light transmission. The first characteristic will allow to decrease the heating needs and as a consequence the carbon dioxide release together with the costs, while the second characteristic will contribute to maintain the crop yield. For safety reasons, the glazing needs to be tempered.

The inventors have found that the object of the invention can be reached thanks to a vacuum insulating glazing unit, comprising an outside glass substrate (GL1) with 2 main surfaces referenced as P1 and P2 and an inside glass substrate (GL2) with 2 main surfaces referenced as P3 and P4 wherein, the P4 main surface of the inside glass substrate is characterized through a specific roughness and is preferably coated with an antireflective layer, said specific roughness is characterized by a Sa parameter comprised between 0.18 and 1.80 μm, a Sz parameter comprised between 1.50 and 10.00 μm and a Rsm parameter comprised between 65 and 125 μm.

More particularly, the specific roughness is characterized as follow:
the parameter Sa being at least 0.185 μm, preferably at least 0.19 μm, more preferably at least 0.20 μm and being at most 1.8 μm, preferably at most 1.7 μm, more preferably at most 1.6 μm,
the parameter Sz being at least 2.0 μm, preferably at least 2.5 μm, more preferably at least 3.0 μm and being at most 10.0 μm, preferably at most 9.5 μm, more preferably at most 9.0 μm,
the parameter Rsm being at least 65 μm, preferably at least 70 μm, more preferably at least 75 μm and being at most 125 μm, preferably at most 120 μm, more preferably at most 115 μm.

Preferably, the antireflective layer is a nano-porous silica layer having a thickness comprised between 80 and 150 nm, preferably between 100 and 120 nm and having a refractive index of at most 1.5, preferably at most 1.4 and more preferably at most 1.38.

Alternatively, the Vacuum insulating glazing unit of any of the invention has both the main surface P4 and the main surface P1 coated with an antireflective coating and for both surface preferably the antireflective coating is a nano-porous silica layer having a thickness comprised between 80 and 150 nm, preferably between 100 and 120 nm and having a refractive index which is at most 1.5, preferably at most 1.4 and more preferably at most 1.38.

Alternatively, the main surface P3 of the vacuum insulating glazing unit of the invention is coated with a low-e stack.

### SUMMARY OF INVENTION

The present inventors have found a very good compromise to have a good PAR light transmittance together with a good thermal insulation. The vacuum insulating glazing (VIG) of the invention is made with two glass substrates. Each of the glass substrates has two main surfaces, the external main surface of the inside glass substrate (P4) is characterized through a particular texturing which results in a specific roughness.

A vacuum-Insulating glazing unit used for the invention is typically composed of at least two glass panes separated by an internal volume in which a vacuum has been generated by virtue of a pump, resulting in an absolute pressure of maximum 0.1 mbar in the space between both glasses. The two glasses are hold at distance thanks to discrete spacers (pillars), in such a way that a typical distance between both glasses is in the range of 50 to 1000 μm. In order to keep the structure hermetically closed, a bonding seal is placed on the periphery, based for example on solder glass. Typically VIG and a method to make them are better described for example in EP3170800A1 and EP3953313A1, which content are incorporated here.

In a first mode of a first embodiment, the glass surface (P4) characterized through a particular texturing, is coated with an antireflective layer.

In a second mode of the first embodiment, the glass surface (P4) characterized through a particular texturing, and the external main surface of the outside glass substrate (P1) are both coated with an antireflective layer.

In a second embodiment, the external side of the inside glass substrate of the VIG unit (P4) has a particular texturing and the internal side of the inside glass substrate of the VIG unit (P3) is coated with a low-e stack.

In a first mode of the second embodiment, the glass surface characterized through a particular texturing (P4), is coated with an antireflective layer. The internal side of the inside glass substrate (P3) is coated with a low-e stack.

In a second mode of the second embodiment, the glass surface characterized through a particular texturing (P4), and the external main surface of the outside glass substrate (P1) are both coated with an antireflective layer. The internal side of the inside glass substrate (P3) is coated with a low-e stack.

For any mode of any embodiment of the invention, said particular texturing of the external side of the inside glass substrate (P4) of the VIG unit has a specific roughness characterized by the Sa parameter comprised between 0.18 and 1.80 μm, a Sz parameter comprised between 1.5 and 10.0 μm and a Rsm parameter comprised between 65 and 125 μm.

For any mode of any embodiment of the invention, said particular texturing of the external side of the inside glass substrate (P4) of the VIG unit has a specific roughness characterized by a Sa parameter being at least 0.185 μm, preferably at least 0.19 μm, more preferably at least 0.20 μm and being at most 1.8 μm, preferably at most 1.7 μm, more preferably at most 1.6 μm.

For any mode of any embodiment of the invention, said particular texturing of the external side of the inside glass substrate (P4) of the VIG unit has a specific roughness characterized by a Sz parameter being at least 2.0 μm, preferably at least 2.5 μm, more preferably at least 3.0 μm and being at most 10.0 μm, preferably at most 9.5 μm, more preferably at most 9.0 μm.

For any mode of any embodiment of the invention, said particular texturing of the external side of the inside glass substrate (P4) of the VIG unit has a specific roughness characterized by a Rsm parameter being at least 65 μm, preferably at least 70 μm, more preferably at least 75 μm and being at most 125 μm, preferably at most 120 μm, more preferably at most 115 μm.

For any mode of any embodiment of the invention, the antireflective coating is advantageously a nano-porous silica layer (a) having preferably a thickness of from 80 nm to 150 nm, preferably of from 100 nm to 120 nm. Preferably the nano-porous silica layer has refractive index of at most 1.5, preferably at most 1.4 and more preferably at most 1.38.

For any mode of the second embodiments, said low-e stack may be any low-e known from the man in the art, said low-e must be convenient to face the internal space of a VIG unit and said the low-e stack should not affect the PAR transmittance in a too large extend.

Thanks to the combined characteristics mentioned above, for all embodiments, the glazing of the invention shows very good performances in terms of PAR transmittance and thermal insulation.

For the first embodiment of the invention, the PAR transmittance of the VIG unit is greater than 86.3%, preferably greater than 87.0% and more preferably greater than 88.0%.

For the second embodiment of the invention, the PAR transmittance (TPAR) of the VIG unit is greater than 82.7%, preferably greater than 83.0% and more preferably greater than 83.9%.

For any embodiment of the invention, the thermal coefficient U, expressed in W/m². K, for the VIG unit of the invention is at most 3.0, preferably at most 2.5. Such value, which seems to be high, is nevertheless a good compromise when the VIG has to be used for a greenhouse glazing. Indeed it allows a sufficient thermal insulation while keeping UV transmission high enough for crop growth, when it is requested.

For the second embodiment, the thermal coefficient U, expressed in W/m². K, for the VIG unit of the invention is below 1.0, preferably below 0.9 and more preferably below 0.8. We also must keep in mind that adding a low-e stack will impact the UV light transmittance. UV transmission based on EN410 remains above 58%.

As a great advantage of the vacuum insulating glazing unit compared to a double glazing with an atmospheric pressure in the space between the two glass substrates, the inventors have observed that the thermal U value is not only still lower but then it is also not dependant of the inclination of the glazing. This means that insulation properties of the roof tilted glasses are as good as the vertical wall. More particularly, the ratio (U_{90°}/U_{22°}) of U value measured when the VIG unit is vertical (U_{90°} at 90° of the ground) and when the VIG is tilted (U_{22°}, at 22° of the ground surface) is comprised between 0.9 and 1.1, preferably between 0.95 and 1.05 and more preferably between 0.98 and 1.02.

In a preferred embodiment, the hortiscatter of the vacuum insulating glazing unit of the invention is comprised between 13 and 63%. The inventor have observed that the hortiscatter is a consequence of the roughness and that it can be quite easily tuned by adjusting the roughness parameters. As a consequence, other hortiscatter values can be reached easily.

As mentioned above, the existence of the hortiscatter is increased thanks to the presence of special microstructure implemented by texturing the glass surface. More particularly the texturing of the glass surface is a random texturing. As a consequence, the textured surface morphology is not a regular pattern and is characterized through the roughness parameters. The roughness is thus a consequence of the random texturing.

The nano-porosity of the antireflective coating is improving the PAR light transmission. The antireflective coating is also responsible for a good hydrophilicity and on each coated sides of the VIG unit, condensation of water occurs as a film instead of droplets.

For all embodiments, the glass substrates are advantageously made of clear glass and even more advantageously of extra clear glass.

As other advantages, the glazing unit of the invention present a good durability. The nano-porous silica layer is also protecting the textured surface from corrosion by acting as diffusion barrier for volatile species inside the core glass, giving enhanced chemical and mechanical durability which enable the longer performance with the minimized deterioration rate, being in line with class A coating based on the norm EN 1096-2 (2012-E). To improve the durability, a glass frit sealing for the VIG may be advantageous.

### BRIEF DESCRIPTION OF DRAWINGS

This and other aspects of the present invention will now be described in more detail, with reference to the appended drawings and by showing various exemplifying embodiments of the invention. The drawings are not to scale and should not be considered as a limitation of the invention.

FIG. 1 shows different types of glass substrates:

1a is a monolithic glass substrate without any treatment nor coating,

1b is a glass substrate with one side comprising the particular texturing of the invention;

1c is a glass substrate with one side comprising the particular texturing of the invention and an antireflective coating;

1d is a glass substrate with one side comprising the particular texturing of the invention together with an antireflective coating and a low-e stack on the opposite side.

FIG. 2 illustrates a vacuum isolating glazing unit of the first embodiment of the invention with the outside glass substrate I, facing the sun and the inside glass substrate II. The drawing indicates how the different sides of the glass substrates are identified (P1 to P4).

2a is a drawing of the first mode of the first embodiment with one antireflective layer on P4

2b is a drawing of the second mode of the first embodiment with one antireflective layer on P4 and one antireflective layer on P1

FIG. 3 illustrates a vacuum isolating glazing unit of the second embodiment of the invention with the outside glass substrate I, facing the sun and the inside glass substrate II. The drawing indicates how the different sides of the glass substrates are identified (P1 to P4). A low-e stack is deposited on the P3 side.

3a is a drawing of the first mode of the second embodiment with one antireflective layer on P4

3b is a drawing of the second mode of the second embodiment with one antireflective layer on P4 and one antireflective layer on P1.

### DESCRIPTION

The main features of the invention are 1°) the glass surface treatment to have the desired hortiscatter thanks to a specific roughness, 2°) the antireflective coatings to keep a good PAR transmission and 3°) the combination of 2 glass sheets to form a vacuum isolating glazing unit for the thermal insulation. A further improvement is described in a second embodiment by adding a low-emissive coating. Each of those characteristics will now be described with more details.

### Definitions

Some terms should be considered as equivalent as
   Glass pane, glass substrate, glass sheet
   Silica layer, nano-porous silica layer
   Low-emissive, low-e
By inside substrate, here and for all the text, we mean the substrate facing the inside of the greenhouse. The outside substrate is the substrate facing the outside of the greenhouse. Considering the substrates of the VIG, external side means both sides opposite to the vacuum space (P1 and P4) while internal side means the sides facing the vacuum space (P2 and P3).
By clear glass, one should understand that the glass substrate has a composition characterized by an iron content expressed in weight percent of Fe₂O₃ which is at most 0.1%. This value drops to at most 0.015% for the extra clear glass.
When a specific range is given for a particular characteristic and without precision, we consider the limits of this range is part of it.
PAR meaning is Photosynthetically active radiation and comprises wavelength between 400 to 700 nm, based on NEN 2675+C1:2018. This is the main part of natural light responsible for photosynthetic activities of plants.
Within the context of horticulture, Hortiscatter is the integral value of geometrical distribution of light intensity by bi-directional transmittance (or reflectance) distribution function BTDF under a given angle of incidence of incoming light beam (3D data), defined by Wageningen University and Research (WUR) in the standard NEN 2675+C1:2018.
Hemispherical light transmission (Tₕₑₘ) is measured following the standard NEN 2675+C1:2018. The hemispherical light transmission is a measure of light transmission at different angles from the point of light incidence.
The refractive index n is calculated from the light spectrum wavelength at 550 nm.
When roughness is considered, the latter is characterized through the Sa, Sz and Rsm values (expressed in micrometers, μm). The roughness parameters were measured by confocal microscopy. The surface parameters (Sa and Sz) according to ISO 25178 standard (part 2 and part 3, 2012F), and the profile parameter (Rsm) by isolating a 2D profile which then gives access to the parameters defined in the ISO 4287-1997 standard. Alternatively, one can use a 3D profilometer for the surface parameters (according to the ISO 25178 standard, part 2 and part 3, 2012F) and a 2D profilometer for the profile parameters (according to the ISO 4287-1997 standard). The texture/roughness is a consequence of the existence of surface irregularities/patterns. These irregularities consist of bumps called “peaks” and cavities called “valleys”. On a section perpendicular to the etched surface, the peaks and valleys are distributed on either side of a “center line” (algebraic average) also called “mean line”. In a profile and for a measurement along a fixed length (called “evaluation length”).
   Sa (arithmetic mean height) expresses, as an absolute value, the difference in height of each point compared to the arithmetical mean of the surface, the Sa parameter is characterized by a standard deviation of 0.1 μm;
   Sz (maximum height) is defined as the sum of the largest peak height value and the largest pit depth value within the defined area, the Sz parameter is characterized by a standard deviation of 0.6 μm;
   Rsm (spacing value, sometimes also called Sm) is the average distance between two successive passages of the profile through the “mean line”; and this gives the average distance between the “peaks” and therefore the average value of the widths of the patterns, the Rsm parameter is characterized by a standard deviation of 1.0 μm.
The water contact angle is the angle made between the tangent to a water drop and the surface of the support. The measure is made following the standard method ASTM C 813-75 (1989)
All measures are given for the tempered glazing or for the vacuum insulating glazing unit made of tempered glass substrates.

The glass substrates used to build the glazing of the invention is a clear or preferably an extra clear glass that intrinsically allows a good light transmittance. More preferably the glass substrates of the invention have a thickness of at least 1 mm, preferably at least 2 mm and more preferably at least 3 mm and at most 6 mm, preferably at most 5 mm and more preferably at most 4.5 mm.

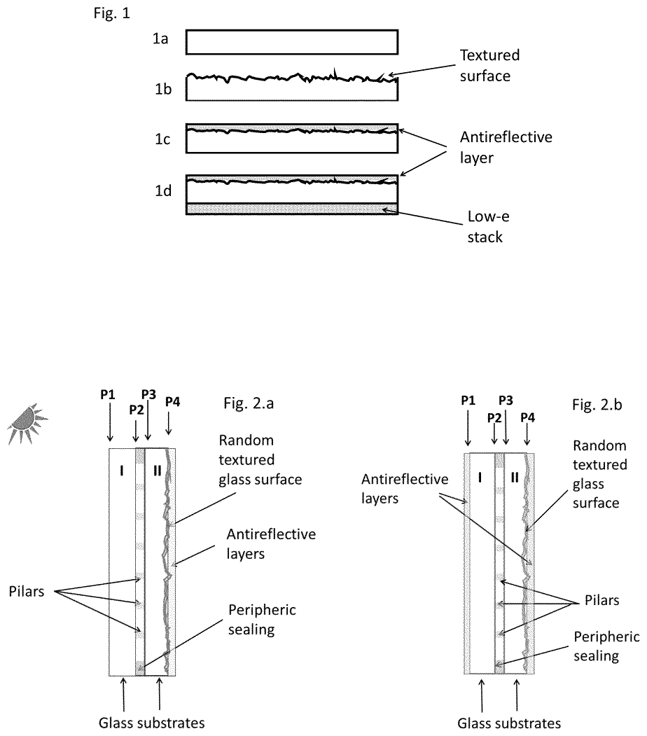

FIGS. 1 (c and d) show 2 examples of a glass substrate used to build a vacuum isolating glazing of the invention: a first embodiment with one main surface of a glass substrate which is textured and the textured surface is coated with an antireflective layer (FIG. 1c) and a second embodiment with one main surface of the glass substrate which is textured and coated with an antireflective layer, as in the first embodiment, and the other main opposite surface is coated with a low-e stack (1d).

For any embodiment, at least one main surface of the glass substrate is textured in such a way that the resulting textured surface has a specific roughness that allows a good light diffusion. The specific roughness of the textured surface of the glass substrate of the invention is characterized with its roughness parameters: Sa, Sz and RSm.

According to the invention, to reach the desired roughness, any known method such as mechanical or chemical process may be convenient as far as the correct roughness is reached. In a preferred embodiment, texturing is obtained by means of a controlled chemical attack. More particularly, the chemical attack is performed with an aqueous solution based on hydrofluoric acid, carried out one or more times. Generally, the aqueous acidic solutions used for this purpose have a pH between 0 and 5 and they can comprise, in addition to the hydrofluoric acid itself, salts of this acid, other acids, such as HCl, H₂SO₄, HNO₃, acetic acid, phosphoric acid and/or their salts (for example, Na₂SO₄, K₂SO₄, (NH₄)₂SO₄, BaSO₄, and the like), and also other adjuvants in minor proportions. Alkali metal and ammonium salts are generally preferred, such as, for example, sodium, potassium and ammonium bifluoride. The acid etching stage according to the invention can advantageously be carried out by a controlled acid attack, for a time which can vary as a function of the acid solution used and of the expected etched surface result.

According to all embodiment of the invention, the at least one textured surface of each glass substrate of the invention is coated with an antireflective coating (FIG. 1c). More particularly, said antireflective coating deposited on the at least one textured surface of each glass substrate of the invention is a nano-porous silica layer having a thickness of from 80 nm to 150 nm, preferably of from 100 nm to 120 nm.

According to a particular aspect of the invention the nano-porous silica layer deposition is performed through a PECVD process as described in EP1679291B1 and incorporated here by reference. The nano-porous SiOₓ film will get its final optical and mechanical properties in a two-step production. At first, the thin film deposited by a PECVD process results in high carbon content SiOₓC_{y}. The layer comprises 5 to 30 at. % of Silicon, 20 to 60 at. % of Oxygen, 2 to 30 at. % of carbon and 2 to 30 at. % of hydrogen. In order to get the final optical and mechanical properties one needs to bake the glass and the film. The carbon is desorbed during the tempering process leaving increased porosity, pores having a mean diameter greater than 5 nm. Increasing porosity results in a smaller refractive index, responsible for the antireflective performance. Preferably, after tempering, the refractive index of the SiOₓ layer is at most 1.5, preferably at most 1.4 and more preferably at most 1.38. Temperatures for any heat strengthened glass are between 650° C.-680° C. Advantageously, the final refractive index is 1.38. Based on the special plasma process the surface of the glass together with the coating will be densified. The chemical bond between the Si group in the coating and the Si group on the surface of the glass at the interface of coating-glass surface is the main reason on the better mechanical durability performances. Furthermore regarding the mechanical behaviour, the coating after bake is harder than the uncoated float glass for both sides.

According to the second embodiment of the invention, one glass substrate having at least one main surface textured and covered with an antireflective coating, is further coated with a low-emissive stack on the opposite side of the antireflective coating (FIG. 1d).

The low-emissive stack of the second embodiment of the invention may be any low-emissive stack well known by the man of the art as far as this stack is compatible for VIG.

According to the second embodiment of the invention, advantageously, the low-emissive coating comprises one silver film, the silver layer has a geometric thickness of at least 7 nm, preferably at least 8 nm and more preferably at least 9 nm. The geometric thickness of silver layer is at most 16 nm, preferably at most 14 nm and more preferably at most 12 nm. Advantageously, the low-emissive coating comprises a single silver layer.

According to the second embodiment of the invention, the silver layer is deposited above a first dielectric coating and below a second dielectric coating. Advantageously, the silver layer is deposited directly above a zinc oxide layer. Advantageously a protecting layer is deposited directly above the silver layer. The protecting may be any protecting layer known in the art, but preferably, the protecting layer comprises a zinc oxide layer.

According to all embodiments of the invention, two glass substrates of the invention are assembled to constitute a vacuum isolating glazing unit by any convenient process. More particularly two spaced apart substantially parallel glass substrates of the invention are hermetically sealed together in such a way to enclose an evacuated low-pressure space/cavity there between. Glass substrates are interconnected by a peripheral edge seal and an array of support pillars/spacers are included between the glass substrates to maintain the spacing between the substrates of the VIG unit.

The FIG. 2 shows the vacuum isolating glazing of the invention comprising two glass substrates of the first embodiment represented in FIG. 1c. The vacuum isolating glazing unit of the first embodiment of the invention comprises a first glass substrate (I) and a second glass substrate (II) wherein the first glass substrate (I) is the outside substrate (facing the exterior of the greenhouse) and the second glass substrate (II) is the inside substrate (facing the interior of the greenhouse). The external main surface of the inside substrate (P4) is textured and coated with an antireflective layer. A second glass substrate is assembled with the first one to a known manner. The two glass substrates are hermetically sealed. Different types of sealing material and different types of spacers are known in the art and any may be used for the purpose of this invention. For example, typical sealing means for VIGs are glass frits and metallic or ceramic solders. One of the most current sealing means is based on solder glass which has a melting point lower than that of the glass. In addition, an array of discrete spacers (or pillars) must be placed between the two glass panes in order to keep both panes at stable distance from each other.

The discrete spacers can have different shapes and are typically made of a material which has sufficient strength to endure the pressure applied by the surfaces of the glass panes. Also, the pillars must be able to withstand high-temperature processes. Any type of pillars may be used for the invention. A stable vacuum cavity is formed in between the two hermetically sealed glass substrates of FIG. 2. The vacuum cavity has a pressure level that is not greater than 0.1 mbar. In order to maintain vacuum over time, a getter may be placed in the VIG (not shown on the figure).

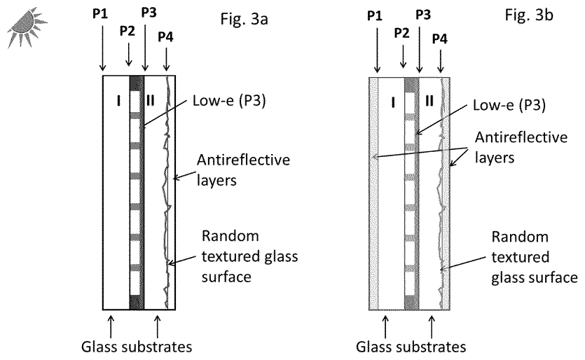

The FIG. 3 shows the second embodiment of the invention where the interior glass substrate is coated with a low-emissive stack on the main surface facing the vacuum space (P3 position). As for the first embodiment, a vacuum isolating glazing unit is assembled in a similar way as described in the previous paragraph.

### DESCRIPTION OF EMBODIMENTS/EXAMPLES

A 4 mm thick monolithic extra clear glass substrate has been etched and coated with a nano-porous silica layer. For the etching, the glass sheet glass has been washed with deionized water and then dried. An acid etching solution, composed by volume of 50% NH₄HF₂, 25% water, 6% concentrated H₂SO₄, 6% of a 50% by weight aqueous HF solution, 10% K₂SO₄ and 3% (NH₄)₂SO₄, at 20-25° C., was allowed to contact the glass surfaces for 1.5 minutes. After removal of the acid solution, the glass surface is rinsed with water and washed. After the etching treatment, the glass substrate has been transferred to a PECVD coating unit and a nano-porous silica layer has been deposited on the etched surface following the process described above (§ [0048]). The resulting glass substrate is referred as GL1.

For the second embodiment, a 4 mm thick monolithic extra clear glass substrate is treated and coated in a similar way as GL1 and is then transferred to a PVD coating unit, where a low-e stack is deposited in a well-known manner on the side opposite to the etched surface. For this example, the low-e stack has following structure, starting from the glass surface: TiO₂ (22)/ZnO (3)/Ag (11.8)/AZO (3)/TiO2 (10)/ZSO5 (12)/SiN (18). Figures in parentheses are indicating the thickness (expressed in nm), AZO means a zinc oxide layer from a ceramic target comprising zinc oxide and aluminum oxide. ZSO5 is a tin zinc oxide layer corresponding to the zinc stannate. This particular stack has been used for the example but is by no way limiting. The resulting glass substrate (corresponding to FIG. 1d) is referred to GL2.

An extra clear glass without any treatment nor coating is referred to GL0.

The glass substrate referred to GL0 is washed and transferred to a PECVD coating unit where a nano-porous silica layer is deposited on one surface of the glass substrate, following the process described above (§ [0048]). The resulting glass substrate is referred as GL3.

The table 1 gives some characteristics of the four glass substrates of the examples above (GL0, GL1, GL2 and GL3). The second column remind the resulting final structure of each glass substrate: all are extra clear glass, AR means antireflective layer.

TABLE 1
characterization of glass substrates.

| | | Etched surface | | | | |
|---|---|---|---|---|---|---|
| | | Sa | Sz | Rsm | T_{PAR} | Hortiscatter |
| | structure | (μm) | (μm) | (μm) | (%) | (%) |
| GL0 | Extra clear | N/A | N/A | N/A | 91.5 | 0% |
| | glass | | | | | |
| GL1 | Textured P4 | 0.65 | 5.57 | 78 | 94.0 | 14% |
| | with AR coating | | | | | |
| GL2 | Textured P4 | 0.65 | 5.57 | 78 | 89.1 | 14% |
| | with AR coating | | | | | |
| | and P3 with | | | | | |
| | low-e | | | | | |
| GL3 | Glass with one | N/A | N/A | N/A | 94.0 | 0% |
| | AR (P1) | | | | | |

The different types of glass substrates of the examples (GL0, GL1, GL2 and GL3) have been assembled following different combination to constitute different examples of vacuum isolating glazing units of the invention. This means that when GL1 or GL2 is used, the etched side is positioned to be at the P4 position of the vacuum glazing unit and when GL3 is used, the antireflective coating is positioned to be at the P1 position of the vacuum glazing unit. The table 2 gives the characteristics of the different arrangements of the examples.

The second column of the table 2 gives the visible light transmittance (TL) expressed in %. The third column gives the PAR light transmittance (PAR), expressed in %. The fourth column gives the solar factor (SF), expressed in %. The fifth column gives the U value measured at 90° (U_{90°}) expressed in W/m²·K and the last column gives the ratio (U_{90°}/U_{22°}) of U value measured when the VIG unit is vertical (U_{90°}, at 90° of the ground) and when the VIG is tilted (U_{22°}, at 22° of the ground surface)

TABLE 2
Vacuum isolating glazing arrangement.

| | TL | T_{PAR} | SF | U | U_{90°}/ |
|---|---|---|---|---|---|
| arrangement | (%) | (%) | (%) | (W/m² · K) | U_{22°} |
| GL0-GL0 | 84.6 | 84.3 | 84.0 | 2.45 | 0.99 |
| GL0-GL1 | 86.6 | 86.4 | 85.4 | 2.45 | 0.99 |
| GL3-GL1 | 88.8 | 88.6 | 87.0 | 2.45 | 0.99 |
| GL0-GL2 | 83.8 | 82.8 | 64.8 | 0.70 | 1.01 |
| GL3-GL2 | 85.9 | 84.0 | 66.1 | 0.69 | 1.01 |

From the table above, it clearly appears that the glazing of the invention allows to improve the light transmission and more particularly the PAR light transmission, while keeping the thermal insulation at the same level

For all examples, all glass substrates have been strengthen in a known manner. Namely the glass substrate is heated in an convective oven at a temperature of 680° C. during 1.5 minutes and is then quenched to room temperature which makes the glass as safety glass according to EN12150.

1: A vacuum insulating glazing unit for a greenhouse, comprising:
an outside glass substrate with 2 main surfaces referenced as P1 and P2, and
an inside glass substrate with 2 main surfaces referenced as P3 and P4,
wherein, the P4 main surface of the inside glass substrate has a specific roughness, said specific roughness is characterized by a Sa parameter comprised between 0.18 and 1.80 μm, a Sz parameter comprised between 1.5 and 10.0 μm and an Rsm parameter comprised between 65 and 125 μm.

2: The vacuum insulating glazing unit of claim 1, wherein the specific roughness is characterized by the Sa parameter being at least 0.185 μm preferably at least 0.19 μm, more preferably at least 0.20 μm and being at most 1.8 μm.

3: The vacuum insulating glazing unit of claim 1, wherein the specific roughness is characterized by the Sz parameter being at least 2.0 μm, and being at most 10.0 μm.

4: The vacuum insulating glazing unit of claim 1, wherein the specific roughness is characterized by the Rsm parameter being at least 65 μm, and being at most 125 μm.

5: The vacuum isolating glazing unit of claim 1, wherein the P4 main surface is coated with an antireflective layer.

6: The vacuum insulating glazing unit of claim 5, wherein the antireflective layer deposited on P4 is a nano-porous silica layer having a thickness comprised between 80 and 150 nm, and has a refractive index which is at most 1.5.

7: The vacuum insulating glazing unit of claim 1, wherein the P4 and the P1 main surfaces are both coated with an antireflective coating.

8: The vacuum insulating glazing unit of claim 7, wherein the antireflective layer is a nano-porous silica layer having a thickness comprised between 80 and 150 nm, and has a refractive index which is at most 1.5.

9: The vacuum insulating glazing unit of claim 1, wherein the P3 main surface is coated with a low-e stack.

10: The vacuum insulating glazing unit of claim 9, wherein the low-e stack has a single silver layer.

11: The vacuum insulating glazing unit of claim 1, wherein the vacuum insulating glazing unit has a PAR light transmittance greater than 80%.

12: The vacuum insulating glazing unit of claim 1, wherein a U value, expressed in W/m²·K, is smaller than 3.0.

13: The vacuum insulating glazing unit of the claim 9, wherein the U value, expressed in W/m²·K, is smaller than 1.0.

14: The vacuum insulating glazing unit of claim 1, wherein a U values ratio (U_{90°}/U_{22°}), where U_{90°} is a U value for a substrate at 90° related to a ground and the U_{22°} is a U value for a substrate at 22° related to the ground, is comprised between 0.9 and 1.1.

15: The vacuum insulating glazing unit of claim 1, wherein the roughness is a consequence of a random texturing.

16: The vacuum insulating glazing unit of claim 1, wherein a vacuum cavity has a pressure level that is not greater than 0.1 mbar.

17: The vacuum insulating glazing unit of claim 1, wherein both glass substrates have a composition characterized by an iron content expressed in weight percent of Fe₂O₃ which is at most 0.1%.

18: The vacuum insulating glazing unit of claim 1, wherein the specific roughness is characterized by the Sa parameter being at least 0.20 μm and being at most 1.6 μm, the Sz parameter being at least 2.0 μm and at most 9.0 μm, and by the Rsm parameter being at least 75 μm and being at most 115 μm.

19: The vacuum insulating glazing unit of claim 8, wherein the antireflective layer has a refractive index which is at most 1.38.

20: The vacuum insulating glazing unit of claim 14, wherein the U values ratio (U_{90°}/U_{22°}) is between 0.95 and 1.05.
